(19) United States
(12) Patent Application Publication
(10) Pub. No.: US 2007/0134009 A1
(43) Pub. Date: Jun. 14, 2007

(54) Fusing unit of image forming apparatus and method for preventing defecting fusing of image

(76) Inventors: Min-Goo Choi, Gunpo-si (JP); Kyung-shig Chung, Suwon-si (JP); Sung-hoon Hong, Suwan-si (JP)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/604,389

(22) Filed: Nov. 27, 2006

(30) Foreign Application Priority Data
Dec. 13, 2005 (KR) 10-2005-0122435

(51) Int. Cl. G03G 15/20

(52) U.S. Cl. 399/33; 399/67; 399/69

(57) ABSTRACT

A fusing unit of an image forming apparatus and method for preventing defective fusing of an image are provided, in which a heating roller includes a heat source and is rotatably installed on a frame, a pressing roller presses a sheet of paper toward the heating roller to fuse a toner image on the paper, a pressing unit elastically bias the pressing roller to the heating roller, and a pressure sensor measures a pressure of the pressing roller. Accordingly, defective fusing of a toner image onto the paper and overheating of the fusing unit can be prevented.

### CROSS-REFERENCE TO RELATED PATENT APPLICATIONS

This application claims the benefit under 35 U.S.C. §119(a) of Korean Patent Application No. 10-2005-0122435, filed on Dec. 13, 2005, in the Korean Intellectual Property Office, the entire disclosure of which is hereby incorporated by reference.

### BACKGROUND OF THE INVENTION

1. Field of the Invention

The present invention relates to a fusing unit of an image forming apparatus. More particularly, the present invention relates to a fusing unit that can prevent defective fusing of images and over-heating in an image forming apparatus and method thereof.

2. Description of the Related Art

A fusing unit of an image forming apparatus includes a frame, a pressing roller, a heating roller, and a pressing unit. The heating roller heats paper to a temperature required to fuse an image, and is rotatably installed on the frame. The heating roller includes a heat lamp generating the heat required to the fusing operation. The pressing roller is installed on the frame to contact the heating roller. The pressing roller rotates while contacting the heating roller to press the paper. In addition, the pressing unit elastically presses the pressing roller toward the heating roller, and is installed on the frame.

A contact portion between the heating roller and the pressing roller is a nip. When the paper passes through the nip, a toner image transferred on the paper is fused on the paper by the high temperature and high pressure.

A degree of fusing the transferred toner image onto the paper is determined by a nip size between the heating roller and the pressing roller. That is, the nip size means a thermal conductive area from the fusing unit to the paper and the strength of pressure applied to the paper by the fusing unit. When the nip size of the fusing unit is large, the heat and the pressure applied to the paper from the fusing unit increase, and thus, the fusing degree of the toner image onto the paper can be improved.

In addition, the nip size is determined by the heating roller and the pressing roller hardness, and the pressure applied on the heating roller from the pressing roller, that is, a pressing force. When a usage count of the fusing unit increases according to the increase number of printed papers, the hardness of the roller may be weakened by the heat or the performance of the pressing unit may be degraded. Due to the above problem and other problems, when the usage count of the fusing unit increases, the nip size of the fusing unit is reduced.

Therefore, a life span of the fusing unit can be evaluated by measuring changes in the nip size of the fusing unit accurately rather than the number of printed papers, and thus, the life span of the fusing unit can be evaluated directly and accurately.

Accordingly, there is a need for an improved fusing unit of an image forming apparatus and method thereof for preventing overheating in the image forming apparatus.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a fusing unit of an image forming apparatus and method thereof, which can prevent defective fusing of a toner image onto the paper.

An aspect of exemplary embodiments of the present invention also provides a fusing unit of an image forming apparatus and method thereof, which can prevent overheating.

According to an aspect of exemplary embodiments of the present invention, there is provided a fusing unit of an image forming apparatus, the fusing unit including a frame; a heating roller including a heat source and rotatably installed on the frame; a pressing roller for pressing a sheet of paper toward the heating roller to fuse a toner image on the paper; a pressing unit for elastically biasing the pressing roller to the heating roller; and a pressure sensor for measuring a pressure of the pressing roller.

In an exemplary implementation, the pressure sensor may be a piezoelectric device, and the fusing unit may further include a controller processing an electric signal input from the pressure sensor to calculate the pressing force.

In an exemplary implementation, the controller may classify the pressing force of the pressing roller as a pressure of normal status, a pressure of defective fusing status, and a pressure of overheating status according to an interrelation of the pressure with a nip size between the heating roller and the pressing roller and stores the classification. When the calculated pressing force corresponds to the pressure of normal status, the controller may normally operate the fusing unit to perform a printing process according to a printing command.

In an exemplary implementation, the controller may heat the heating roller to increase a temperature of the heating roller and reduce a rotating speed of the heating roller, if the calculated pressing force corresponds to the pressure of the defective fusing status.

In an exemplary implementation, the controller may stop heating the heating roller if the calculated pressing force corresponds to the pressure of the overheating status.

### BRIEF DESCRIPTION OF THE DRAWINGS

The above and other objects, features and advantages of certain exemplary embodiments of the present invention will be more apparent from the following description taken in conjunction with the accompanying drawings in which:

FIG. 1 is a schematic side view of a fusing unit of an image forming apparatus according to an exemplary embodiment of the present invention;

FIG. 2 is a schematic front view of the fusing device of the image forming apparatus according to an exemplary embodiment of the present invention;

FIG. 3 is a schematic graph illustrating an interrelation between a pressing force and a nip size to determine a status of the fusing device of the image forming apparatus according to an exemplary embodiment of the present invention; and

FIG. 4 is a flow chart illustrating printing processes of the image forming apparatus using the fusing device according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

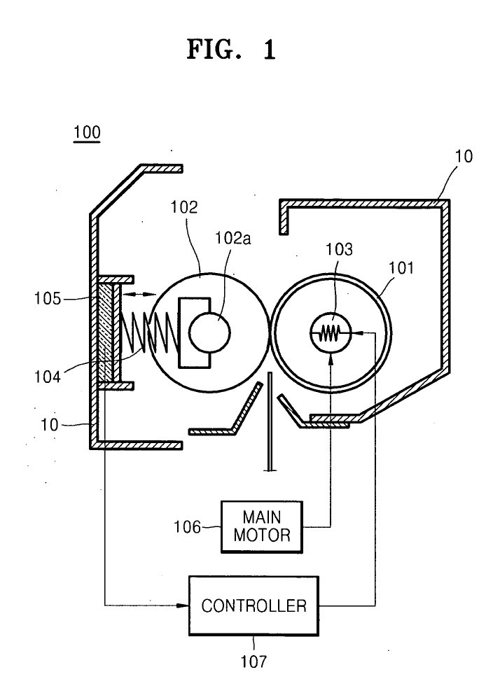

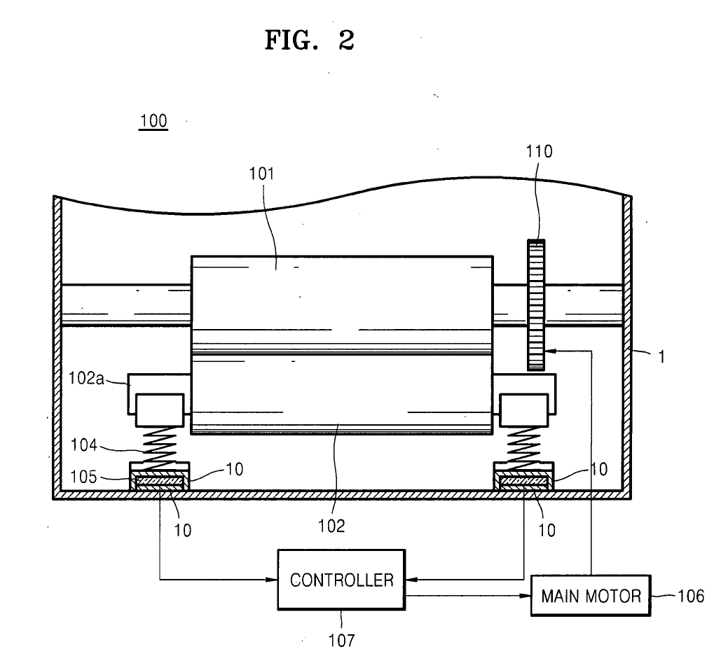

FIG. 1 is a schematic side view of a fusing unit of an image forming apparatus according to an exemplary embodiment of the present invention, and FIG. 2 is a schematic front view of the fusing device of the image forming apparatus according to an exemplary embodiment of the present invention.

Referring to FIGS. 1 and 2, a fusing device 100 of an image forming apparatus according to an exemplary embodiment of the present invention includes a frame 10, a heating roller 101, a pressing roller 102, a pressing unit 104, a pressure sensor 105, and a controller 107.

The frame 10 is installed in a main body 1 of the image forming apparatus, and protects the heating roller 101 and the pressing roller 102 by surrounding them.

The heating roller 101 is rotatably installed in the frame 10. The heating roller 101 is generally formed as a cylinder including a coating layer obtained by coating Teflon, and the like, on a surface thereof. In addition, a heat lamp 103 is installed in an inner center portion of the heating roller 101. The heat lamp 103 generates heat in the heating roller 101, and the heating roller 101 is heated by the heat lamp 103. A halogen lamp or a heater generating Joule heat by an electric resistance can be used as the heat lamp 103.

The pressing roller 102 is installed on a side of the heating roller 101 to provide contact with the heating roller 101. The pressing roller 102 is elastically supported by the pressing unit 104 that will be described later to press the heating roller 101. Thus, a sheet of paper passing through a contact portion between the heating roller 101 and the pressing roller 102, that is, a fusing unit nip, is pressed by a predetermined pressure. Therefore, a toner image formed on the sheet of paper in powder status is fused onto the paper by being pressed and heated while passing through the fusing unit nip.

The heating roller 101 is engaged with a gear portion 110, and is driven when the gear portion 110 operates. When the heating roller 101 operates, the pressing roller 102 contacting the heating roller 101 operates. The gear portion 110 is driven by a main motor 106 installed in the frame 10, and the main motor 106 is driven by receiving an electric signal from the controller 107 that will be described later.

The pressing unit 104 supports an axis 102a of the pressing roller 102, and elastically biases the pressing roller 102 toward the heating roller 101. Then, the pressing roller 102 can supply the pressing force to the heating roller 101. The pressing unit 104 includes a pressing spring.

The pressure sensor 105 is installed on the frame 10 to receive the pressure of the pressing unit 104. In more detail, the pressure sensor 105 supports an end portion of the pressing unit 104, that is, an end opposite to the end supporting the pressing roller 102. That is, the pressing unit 104 may be directly installed on the pressure sensor 105, or may be installed on the frame 10, to which the pressure sensor 105 contacts. When the pressure sensor 105 is installed on the frame 10, the frame 10 finely moves in-a horizontal direction according to the change of elastic force of the pressing unit 104, and then presses the pressure sensor 105 or release the pressure onto the pressure sensor 105. The pressure sensor 105 can then measure the change of pressing force. The pressure sensor 105 may be a piezoelectric device.

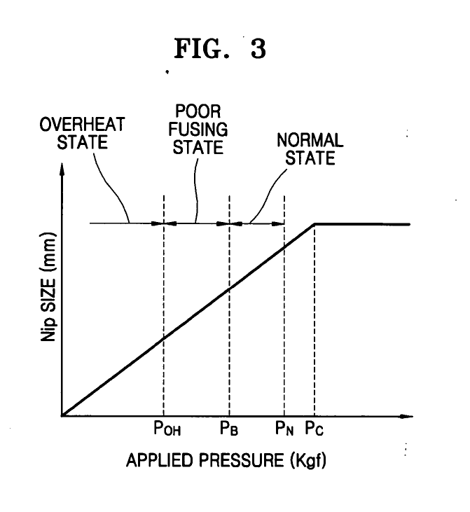

FIG. 3 is a graph schematically illustrating an interrelation between the pressing force and the nip size for determining a status of the fusing unit in the image forming apparatus according to an exemplary embodiment of the present invention.

Referring to FIG. 3, the graph on the interrelation between the pressing force and the nip size of the fusing unit can be obtained through experiments. The graph can be changed according to the size, structure, temperature, and material of the fusing unit 100, and thus, cannot be uniform.

In FIG. 3, P_{C} denotes a marginal pressing force, within which an elastic force of the pressing unit 104 can be recovered. That is, when the pressing unit 104 receives a pressure greater than P_{C}, the pressing unit 104 is transformed and the elastic force of the pressing unit 104 cannot be recovered. Therefore, the pressure in a predetermined range under the marginal pressure P_{C}, that is, the pressure between P_{B} and P_{N}, is applied to the pressing unit 104. The pressing force comprised in the range between the P_{B} and P_{N} is regarded as a normal status.

When the number of using the fusing unit 100 increases due to the number of printed papers, the elastic force of the pressing unit 104 gradually decreases. The reducing of an elastic force of the pressing unit 104 means that a tensile force of the pressing unit 104 is degraded, and consequently, that the force of the pressing unit 104 for supporting the pressing roller 102 and elastically biasing the pressing roller 102 toward the heating roller 101 is reduced. When the pressing force decreases under P_{B}, the contact portion between the pressing roller 102 and the heating roller 101, that is, the size of the fusing nip, becomes smaller, and thus, defective fusing occurs.

When the pressing force is further dropped under P_{OH}, the fusing unit 100, that is, the heating roller 101 and/or the pressing roller 102 are overheated and a thermal transformation occurs on surface of the heating roller 101 and/or the pressing roller 102. If the thermal transformation occurs on the surface of the heating roller 101 and/or the pressing roller 102, the contact portion between the heating roller 101 and the pressing roller 102 is melted, and the elastic force of the pressing unit 104 is degraded so that the pressing force is dropped under P_{OH}. If the pressing force is in a range between P_{OH} and P_{B}, the apparatus is in a defective fusing status. If the pressing force is under P_{OH}, the apparatus is in an overheating status.

The pressing force of the pressing roller 102 is classified as various pressure ranges according to the interrelation with the nip size through experiments, and the controller 107 stores the pressure of normal status, the pressure of defective fusing status, and the pressure of overheating status that are divided according to the pressure range.

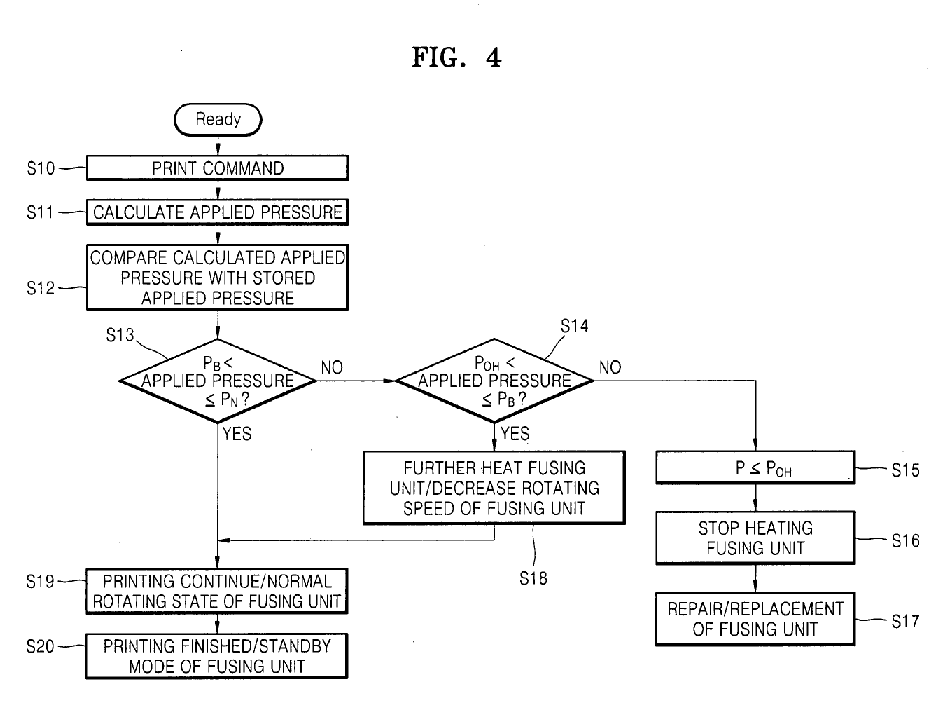

FIG. 4 is a flow chart illustrating printing processes using the fusing unit of the image forming apparatus according to an exemplary embodiment of the present invention.

When a printing command is input (S10), the controller 107 processes an electric signal input from the pressure sensor 105 to calculate a pressing force (S11).

In addition, the controller 107 compares the calculated pressing force to the stored pressing force data (S12).

If the calculated pressing force corresponds to the pressure of normal status in the stored pressure data (S13), the controller 107 normally operates the fusing unit 100 so that the printing operation can be performed according to the printing command (S19). Afterwards, when the printing operation is finished, the fusing unit 100 is changed to a standby mode (S20).

If the calculated pressing force corresponds to the pressure of defective fusing status in the stored pressure data (S14), the controller 107 heats the heat lamp 103 to increase the temperature of the heating roller 101, or controls the main motor 106 to reduce a driving speed of the fusing unit 100, that is, a rotating speed of the heating roller 101 (S18). That is, since the nip size of the fusing unit 100 is reduced under the pressure of defective fusing status, the heat generated by the heating roller 101 cannot be efficiently transmitted to the paper through the nip of the fusing unit 100. To solve the above problems, the temperature of the heating roller 101 is increased, or the rotating speed of the heating roller 101 is decreased so that the time of passing the nip by the paper can be increased. Then, the heat of the heating roller 101, which is required to fuse the toner image, can be sufficiently transmitted to the paper.

In addition, if the calculated pressing force corresponds to the pressure of overheating status (S15), the controller 107 stops heating the fusing unit 100 and drives the heating roller 101 (S16). Then, the overheating of the fusing unit 100 may not cause a fire, or damage adjacent elements. Next, if the pressing force corresponds to the pressure of overheating status, it means that the surface of the heating roller 101 and/or the pressing roller 102 are thermally transformed. Thus, the user should fix the fusing unit 100 or replace the fusing unit 100 with a new fusing unit (S17).

According to exemplary embodiments of the present invention, the fusing unit of the image forming apparatus can prevent defective fusing of toner images.

In addition, according to exemplary embodiments of the present invention, the overheating of the fusing unit can be prevented.

While the present invention has been shown and described with reference to certain exemplary embodiments thereof, it will be understood by those of ordinary skill in the art that various changes in form and details may be made therein without departing from the spirit and scope of the present invention as defined by the appended claims.

What is claimed is:

1. A fusing unit of an image forming apparatus, the fusing unit comprising:
a frame;
a heating roller including a heat source and rotatably installed on the frame;
a pressing roller for pressing a sheet of paper toward the heating roller to fuse a toner image on the paper;
a pressing unit for elastically biasing the pressing roller to the heating roller; and
a pressure sensor for measuring a pressure of the pressing roller.

2. The fusing unit of claim 1, wherein the pressure sensor comprises a piezoelectric device, and the fusing unit further comprises a controller for processing an electric signal input from the pressure sensor to calculate a pressing force.

3. The fusing unit of claim 2, wherein the controller classifies the pressing force of the pressing roller as a pressure of normal status, a pressure of defective fusing status, and a pressure of overheating status according to an interrelation of the pressure with a nip size between the heating roller and the pressing roller and stores the classification, and when the calculated pressing force corresponds to the pressure of normal status, the controller operates the fusing unit to perform a printing process according to a printing command.

4. The fusing unit of claim 2, wherein the controller heats the heating roller to increase a temperature of the heating roller and reduce a rotating speed of the heating roller, if the calculated pressing force corresponds to the pressure of defective fusing status.

5. The fusing unit of claim 2, wherein the controller stops heating the heating roller if the calculated pressing force corresponds to the pressure of overheating status.

6. A method for preventing a defecting fusing of an image, the method comprising:
pressing a sheet of paper toward a heating roller to fuse a toner image on a sheet of paper;
elastically biasing a pressing roller to the heating roller; and
measuring a pressure of the pressing roller with a pressure sensor.

7. The method of claim 6, further comprising processing an electric signal input from the pressure sensor to calculate a pressing force.

8. The method of claim 7, further comprising classifying the pressing force of the pressing roller as a pressure of normal status, a pressure of defective fusing status, and a pressure of overheating status according to an interrelation of the pressure with a nip size between the heating roller and the pressing roller and storing the classification.

9. The method of claim 8, wherein, when the calculated pressing force corresponds to the pressure of normal status, performing a printing process according to a printing command.

10. The method of claim 8, further comprising heating the heating roller to increase a temperature of the heating roller and reduce a rotating speed of the heating roller, if the calculated pressing force corresponds to the pressure of defective fusing status.

11. The method of claim 8, further comprising stopping the heating of the heating roller if the calculated pressing force corresponds to the pressure of overheating status.
